(19) United States
(12) Patent Application Publication
(10) Pub. No.: US 2009/0130962 A1
(43) Pub. Date: May 21, 2009

(54) FILLING MACHINE AND A FILLING METHOD

(75) Inventors: Peter Willburger, Baindt (DE); Gerhard Mueller, Schemmerhofen (DE)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: ALBERT HANDTMANN, Biberach (DE)

(21) Appl. No.: 12/271,983

(22) Filed: Nov. 17, 2008

(30) Foreign Application Priority Data
Nov. 20, 2007 (EP) 07 022 489.4

(51) Int. Cl. A22C 11/02

(52) U.S. Cl. 452/31

(57) ABSTRACT

A filling machine and a method of filling foodstuffs e.g. into sausage casings, with the filling machine having supplied thereto containers in which a foodstuff is stored, and a machine control unit. In order to guarantee a correct operation of the filling machine, a data reader receives container data stored in a storage means at the respective container, whereby the machine control unit is implemented such that the filling process is executed in dependence upon the container data read.

### CROSS-REFERENCE TO RELATED APPLICATION

The present application claims the benefit of priority of European Patent Application No. 07022489.4, filed Nov. 20, 2007. The entire text of the priority application is incorporated herein by reference in its entirety.

### FIELD OF THE DISCLOSURE

The disclosure relates to a filling machine and to a method of filling foodstuffs e.g. into sausage casings.

### BACKGROUND

In food-processing enterprises, filling and dosing machines which have containers supplied thereto are often used. These containers are filled with the prepared foodstuff, e.g. sausage meat, in other departments or areas of the respective firms and transported to the filling machines. On the transport paths or in the supply areas of the filling machines, longer container waiting times may result, if, for example, containers with products which were produced later are filled first. Confusion may also occur, if, for example, a plurality of product lines with different products produce in parallel.

Up to now, stainless steel containers, so-called sausage meat trucks (sausage meat trolleys), have been used in food-processing enterprises, especially in meat-processing enterprises. The sausage meat is prepared in a so-called cutter and filled batchwise into sausage meat trucks for the purpose of further transport. A cutter filling corresponds e.g. to a batch and may comprise a plurality of sausage meat truck fillings. These filled sausage meat trucks are then transported to filling machines, e.g. vacuum filling machines. Due to the batch size, a plurality of sausage meat truck are often present in the supply area, often in close proximity, so that it may occur that batches which were produced earlier are filled or packed later.

The batch identification concerning the nature and the time of production of the content is often accomplished by handwritten slips of paper which are attached to the sausage meat truck or added to the respective sausage meat truck. In some cases the sausage meat trucks used are also sausage meat trucks with a permanent identification, e.g. a bar code.

Nevertheless, confusion problems often arise, in particular when a plurality of product lines with different products produce in parallel. The above-described measures are also incapable of effectively preventing the containers from being filled in an incorrect sequence.

### SUMMARY OF THE DISCLOSURE

On this basis, it is the object of the present disclosure to provide a filling machine as well as a suitable method which allow a troublefree and correct sequence of operating steps during filling.

In accordance with the present disclosure, a data reader is provided, which reads and receives container data stored in a storage means at the respective containers, the machine control unit being implemented such that the filling process is executed in dependence upon the container data read. Due to the fact that the container data are read before the filling process is executed, faults during filling can be prevented effectively. The filling process and, in particular, the charging is thus carried out correctly or, alternatively, not at all. In addition, a confusion of different products can be avoided insofar as incorrect products will not be accepted for further processing. Also the sequence (first in, first out) can be observed. Furthermore, sausage meat that has been waiting too long for further processing will not be not accepted by the filling machine. Nor are products with a temperature above normal accepted. A suitable filling program can be selected automatically in dependence upon the container data.

According to a special embodiment of the present disclosure, a computer network (referred to herein as a PC network) is provided, which has stored therein container data associated with the container data read, the machine control unit being connected to the PC network. This has the advantage that only a small amount of data has to be stored at the container itself, e.g. only the container identification, and that additional data concerning the container in question are stored in a PC network and can be retrieved from said network.

A data reader can transmit the read data directly to the machine control unit and/or to the PC network, which is e.g. a host computer.

According to a preferred embodiment, the storage means is an RFID chip and the data reader is an RFID reader.

It will be of advantage when the data reader is an RFID reader/writer so that information can be transmitted from the machine control unit to the RFID chip. This can be helpful for subsequent processes, e.g. cleaning etc. In addition, it can be stored on the chip that the respective content has waited too long for further processing and is no longer suitable for use.

According to a further embodiment, the reader can also be a laser scanner which scans e.g. a bar code on the container. The bar code may also comprise different container data. It is, however, also possible that the laser scanner only scans the container identification and that additional container data, which are associated with the container identification, are stored in the PC network and can be retrieved from said network.

In the case of the method according to the present disclosure, container data are first stored in a storage means provided on the container, whereupon the container data are read, after transporting the container to the filling machine, and the filling process is controlled in dependence upon the container data.

The reader need not necessarily be arranged directly in the filling machine, but it may e.g. also be provided outside of the machine or it may be integrated in a downstream machine, e.g. a twist-off line, i.e. it can influence the filling machine directly or indirectly.

According to an advantageous embodiment, the container data stored in the storage means originate from at least one, preferably from a plurality of units participating in the production process, such as: cutter, weighing machine, cleaning equipment, manual input unit.

It follows that different items of information can be stored in the storage means, at least part of said information being then used for controlling the filling process.

According to a preferred embodiment, the container data indicate the nature and/or the temperature of the content of the container and/or the time at which the container was filled, the filling machine being controlled such that, in the case of non-admissible container data, the container will not be accepted by the filling machine. Non-admissible container data are container data which do not correspond to data or values that have been determined previously and stored in the control unit.

It is thus possible that the containers which have been filled first will be accepted first by the filling machine. It is also possible to select a suitable filling program in dependence upon the nature of the filling of the container. This guarantees a correct operation of the filling machine.

According to an advantageous embodiment, data transmission from the data reader to the machine control unit and/or the PC network takes place in a wireless and contactless mode. Such wireless data transmission is particularly hygienic and not interference-prone in the field of food processing where wet-cleaning is carried out.

The read container data can then also be documented.

A filling system then comprises a filling machine according to the present disclosure as well as a container with a storage means for storing container data.

According to an advantageous embodiment, the container has arranged thereon a display which optically displays at least part of the data stored.

### BRIEF DESCRIPTION OF THE DRAWINGS

In the following, the present disclosure will be explained in detail making reference to the drawings, in which:

FIG. 1 shows, in a highly schematic representation, a first embodiment of the present disclosure.

FIG. 2 shows, in a highly schematic representation, an additional embodiment of the present disclosure.

### DETAILED DESCRIPTION OF THE PREFERRED EMBODIMENT

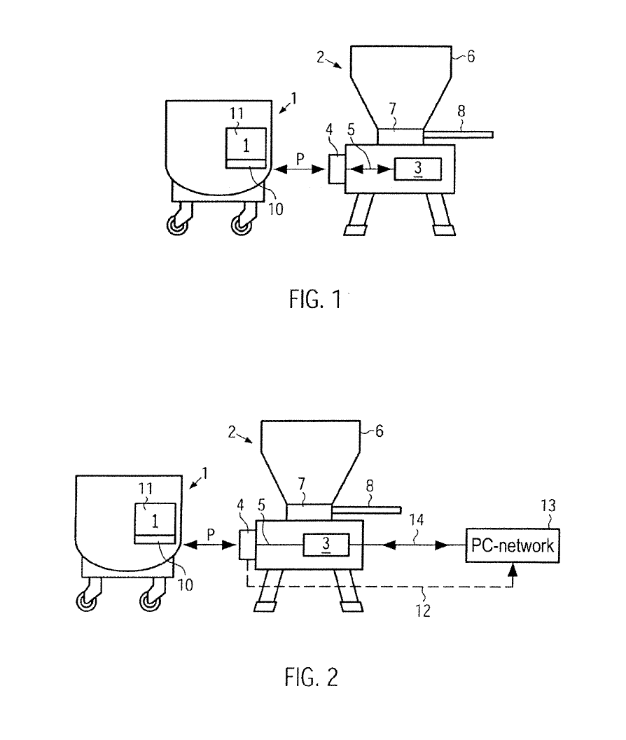

FIG. 1 shows, in a highly schematic representation, a system for filling foodstuffs e.g. into sausage casings. The system comprises a container 1 into which a foodstuff, e.g. sausage meat, has been filled. The container is e.g. a stainless steel container with a filling volume of approx. 2001-3001 which serves here as a so-called sausage meat truck. The foodstuff, which is here sausage meat, was prepared in a cutter and filled batchwise into a plurality of sausage meat trucks. The container 1 is here provided with a storage means 10 arranged on the outer side thereof. It goes without saying that this storage means 10 may also be arranged at some other point on or in the container. The storage means 10 has stored therein container data concerning the container in question. The data in the storage means 10 can originate from the units participating in the production process, such as cutters, weighing machines, cleaning equipment, manual input units, etc., and they were transmitted via suitable means or via a plurality of suitable means (such as RFID writer, bar code printer, etc.) to the storage means 10.

Items of information stored in the storage means can e.g. be the following ones: a sausage meat truck number, the nature of the content of the container, the batch number of the content (a cutter filling corresponds e.g. to a batch), the time of production/charging of the sausage meat truck content, the location of production of the sausage meat truck content, the sequence of charging, the weight of the content, the temperature of the content, the time of emptying the sausage meat truck, i.e. the transfer of the content of the sausage meat truck to the hopper of the filing machine, the time when the sausage meat truck was cleaned last, etc.

In addition, the system comprises a filling machine 2, which is here a vacuum filler, for producing stuffed sausages, said vacuum filler comprising a hopper 6 into which the sausage meat is filled, a conveyor 7 by means of which the sausage meat is fed into a filling tube 8. From said filling tube 8 the sausage meat is then pushed into the sausage casings so as to produce sausages. The filling machine is provided with a machine control unit 3 which controls the filling process.

Furthermore, the filling machine comprises a data reader 4 capable of receiving the container data stored in the storage means 10 on the respective containers 1. The data reader 4 is here directly arranged on or in the filling machine. However, this need not necessarily be the case. The data reader may also be arranged in spaced relationship with the filling machine or it may e.g. be integrated in a machine, e.g. in a twist-off line, arranged downstream of the filling machine, i.e. it can influence the filling machine directly or indirectly.

The data reader 4 is implemented such that it is able to transmit data to the machine control unit 3 via a line 5 or in a wireless mode. It follows that the machine control unit can execute the filling process in dependence upon the container data read.

The container data can e.g. be used for:

batch tracing and process documentation, avoidance of a mix-up of different products, incorrect products being then not accepted for further processing. The container data can also be used for observing a correct sequence (first in, first out). Foodstuffs that have been waiting too long for further processing will not be not accepted by the filling machine. Nor are products with a temperature above normal accepted by the filling machine. In addition, a suitable filling program can be selected automatically on the filling machine in response to the container data read.

It will be advantageous when the storage means 10 is an RFID chip. The data reader 4 is then an RFID reader; the reader 4 may also be a reader/writer which transmits to the RFID chip information, i.e. data from the machine control unit, such as the moment in time at which the content of the container is emptied into the hopper of the filling machine. Data transmission between the storage means and the data reader 4 is executed in a wireless and contactless mode and is therefore particularly hygienic and not interference-prone in the field of food processing where wet-cleaning is carried out.

The data reader 4 for reading and accepting container data may also be a laser scanner. In this case, the storage means 10 can, for example, be an applied bar code, e.g. a bar code label.

In the embodiment shown in FIG. 1, the container data are transmitted from the data reader 4 directly to the machine control unit 3.

The embodiment shown in FIG. 2 corresponds to the embodiment shown in FIG. 1 with the exception that the system comprises here an additional PC network 13. The PC network has stored therein additional container data which are associated with the container data stored in the storage means 10. The machine control unit 3 is connected to the PC network 13 as well. Hence, the data reader 4 may, for example, read from the storage means 10 only part of the container data, e.g. only the container identification. The PC network can then be used for supplying the machine control unit 3 with additional container data concerning a specific container 1, said data being supplied e.g. via a line 14 or in a wireless mode. The PC network may e.g. comprise the PCs of a plurality of units participating in the production process. The network 13 may also include a suitable host computer which has then connected thereto the control unit 3. In this case, the data reader 4 can also directly supply the read container data to the PC network, e.g. a host computer, via a line 12 or in a wireless mode. The network can then, in turn, transmit the data to the machine control unit 3.

In the following, the method according to the present disclosure will be explained in the detail with reference to FIGS. 1 and 2.

Prior to the actual filling process carried out e.g. in sausage production processes, the sausage meat is first prepared in a cutter and then batchwise filled into the sausage meat truck 1 for the purpose of further transport. Before the container is transported to the filling machine 2, container data for the container 1 are stored in the storage means 10. This can be done e.g. in that an RFID writer writes information onto the RFID chip. It is also imaginable to print a bar code label which is then attached to the container.

When the container 1, in this case the sausage meat truck, is then transferred to the filling machine 2, the data reader 4 can read the container data stored in the storage means 10, as indicated by the arrow P. The data read are transmitted to the control unit 3. As has also been described in connection with FIG. 2, it is also possible to supply, in response to the container data read, e.g. the container identification, additional container data of the container in question to the machine control unit 3 from a PC network 13.

The machine control unit 3 can then execute the filling process in dependence upon the container data read. In so doing, the machine control unit 3 compares at least part of the container data with stored data. If these stored data should not be consistent with the container data supplied to the machine control unit 3, the machine control unit 3 will determined, in accordance with a preferred embodiment, that the container data in question are not admissible.

In the case of non-admissible container data, the container 1 will not be accepted by the filling machine 2 for executing the further filling process. For this purpose, the filling machine may be equipped with e.g. a display, which is not shown and which displays information to the effect that the container cannot be accepted. In addition, the filling machine can also prevent the acceptance of the respective container by blocking the lifting device and by thus preventing the content of the container from being emptied into the hopper of the filling machine. If the container data read correspond, however, to the previously stored target data, the container 1 will be accepted.

The machine control unit 3 may also control the filling process such that containers 1 which were filled first by the cutter will be accepted first so that a specific sequence can be observed.

When the container data indicate the nature and/or the temperature of the content of the container and/or the time at which the container was filled, it will be guaranteed that only the adequate type of filling, whose temperature has not been exceeded and which has not yet waited too long for further processing, will be processed. This will be of advantage, especially in cases where a plurality of production lines with different products is involved, and guarantee correct processing.

For different foodstuffs, i.e. different types of filling, it is also possible to select a corresponding filling program which is adapted to the foodstuff in the container 1 and to the product to be produced.

The data read can also be documented.

As can be seen in FIGS. 1 and 2, the containers 1 can additionally be provided with a display 11 displaying at least part of the container data, e.g. the number of the sausage meat truck or the time of production or the nature of the content of the sausage meat truck, so that the staff will be able to discern immediately which container or sausage meat truck should be supplied to a filling machine 2.

1. A filling machine, in the form of a vacuum filler for filling foodstuffs, comprising:
a plurality of containers having the respective foodstuff stored therein,
a machine control unit,
a data reader which receives container data stored in a storage means at the respective containers, and wherein
the machine control unit is implemented such that the filling process is executed in dependence upon read container data.

2. A filling machine according to claim 1, and a computer network having stored therein container data associated with the container data read, the machine control unit being connected to the computer network.

3. A filling machine according to claim 1, wherein the data reader transmits the data directly to one of the machine control unit, the computer network, or a combination thereof.

4. A filling machine according to claim 1, wherein the storage means is an RFID chip and the data reader is an RFID reader.

5. A filling machine according to claim 4, wherein the data reader is an RFID reader/writer which is able to transmit information from the machine control unit to the RFID chip.

6. A filling machine according to claim 1, wherein the data reader is a laser scanner.

7. A filling machine according to claim 6, wherein the laser scanner scans a container identification and additional container data, which are associated with the container identification, are stored in the computer network.

8. A method of filling foodstuffs by means of a filling machine which has supplied thereto containers having the respective foodstuff stored therein, comprising:
a) storing container data in a storage means provided on the container,
b) reading the container data, and
c) executing the filling process in dependence upon the container data read.

9. A method according to claim 8, and originating the container data from at least one of the group of units including participating in the production process:
a cutter, a weighing machine, cleaning equipment, and a manual input unit.

10. A method according to claim 8, and
utilizing the container data to indicate one of the nature of the content of the container, the temperature of the content of the container, the time at which the container was filled, and a combination thereof, and
controlling the filling machine such that, in the case of non-admissible container data, the container will not be accepted by the filling machine.

11. A method according to claim 10, wherein the containers which have been filled first will be accepted first by the filling machine.

12. A method according to claim 10, and selecting a suitable filling program in dependence upon the nature of the filling.

13. A method according to claim 8, and using a wireless and contactless mode to transmit data from the data reader to one of the machine control unit, the PC network, or a combination thereof.

14. A method according to claim 8, and documenting the read container data.

15. A filling system comprising a filling machine formed according to claim 1, and wherein the system additionally comprises a container with a storage means for storing container data.

16. A filling system according to claim 15, wherein the container has arranged thereon a display which optically displays at least part of the data stored in the storage means.

17. The filling machine according to claim 1, wherein the vacuum filler fills foodstuffs into sausage casings.

18. The filling machine according to claim 8, wherein the foodstuffs are filled into sausage casings.

19. The method according to claim 9, and originating the container data from a plurality of such production process participating units.

20. The filling machine according according to claim 1, wherein the filling machine is a vacuum filler.
